(19) United States
(12) Patent Application Publication
(10) Pub. No.: US 2009/0070635 A1
(43) Pub. Date: Mar. 12, 2009

(54) METHOD OF IMPROVING THE INTEGRITY AND SAFETY OF AN AVIONICS SYSTEM

(75) Inventors: David DEPRAZ, Valence (FR); Jacques Coatantiec, Fauconnieres (FR); Alain Renard, Chabeuil (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 12/167,711

(22) Filed: Jul. 3, 2008

(30) Foreign Application Priority Data
Jul. 6, 2007 (FR) 07 04903

(51) Int. Cl. G06F 11/28

(52) U.S. Cl. 714/47; 714/E11.178

(57) ABSTRACT

The present invention relates to a method of improving the integrity and safety of a system, this method making it possible, on the one hand, to detect and to locate an anomaly of a system, and on the other hand to estimate the impact of such an anomaly on the degradation of performance, with a view to attaining the safety level required and to making the data provided by this system safe, and this method is characterized in that it consists, in a system comprising sub-assemblies, in monitoring the proper operation of sub-assemblies by checking their respective transfer functions in the operational mode with the aid of stimuli dispatched to these sub-assemblies.

### RELATED APPLICATIONS

The present application is based on, and claims priority from, French Application Number 07 04903, filed Jul. 6, 2007, the disclosure of which is hereby incorporated by reference herein in its entirety.

### FIELD OF THE INVENTION

The present invention pertains to a method of improving the integrity and safety of a system, and in particular of an avionics system.

### BACKGROUND OF THE INVENTION

Currently, the problem of making radionavigation measurements safe represents a critical point for so-called GNSS applications, and often prevents the use thereof in the guise of sole radionavigation means of aircraft.

In the aeronautical sector, obtaining an airworthiness certificate for an item of equipment is one of the most expensive and most difficult aspects of the design of any aircraft, and in particular of its electronic flight system (also called the avionics system).

This difficulty is related to the increasing dependence of aircraft and their crew on avionics systems. This dependence has given rise to a heavy duty of responsibility regarding the robustness of these systems. A key requirement in the design of avionics systems is that they must never give rise to a catastrophic situation, or, in practice that the probability of occurrence of a catastrophic situation is negligible.

All the parts of an aircraft are subject to safety analyses. As far as avionics systems are concerned, these analysis procedures are dictated by institutional authorities, such as for example the FAA or the EASA for civil aviation. In the military world, the safety rules are in general less constraining.

Safety methodologies have a significant impact on the architecture of the system and on its components. To summarize, it may be considered that the safety requirements give rise to two types of constraints on avionics equipment:
quantitative constraints on equipment reliability (rate of faults per hour), integrity (probability of an item of equipment delivering erroneous information without error detection), etc.
qualitative constraints that pertain to the development process and that are formalized in standards (for example RTCA-DO254 and RTCA-DO178 for hardware and software developments). These standards impose constraints on the development methodology, tests, checks, etc., compliance with which is presumed to culminate in secure equipment designs. In general, these standards have several levels of requirement (for example: A, B, C, etc.) depending on “criticality” level (development level).

Compliance with these constraints, notably the qualitative constraints, can pose problems, in particular in cases where technical, budgetary or legal constraints impose the use of a component or sub-assembly that has not been developed with the qualitative level required for its application in aeronautics, as is the case for example with microprocessors.

The certification rules already provide for cases in which components or sub-systems not developed to the level required are used inside a system which is itself developed to the level required. These tolerated “exceptions” are commonplace for electronic components (microprocessors, memories, etc.). In these cases, qualitative non-conformity regarding development is currently resolved through the following procedures:
exhaustive testing of the component. This procedure consists in testing the component in all possible configurations, but it is in practice difficult to implement for complex systems, with memory or containing software.
testing through use. This procedure is the simplest for all commonly used components. The intensive use of the components, even in sectors outside of aeronautics, is considered to be a sufficient guarantee of their safety. This procedure is often used for microprocessors, but it is unfounded for relatively rare or little used components.

Moreover, safety procedures exist that are conventionally based on a development methodology associated with an analysis of the occurrence of hardware failures and of their possible impacts on the performance of the systems implementing them.

These known procedures cannot therefore be applied to systems integrating elements not developed according to the appropriate level of methodology.

### SUMMARY OF THE INVENTION

The subject of the present invention is a method of improving the integrity and safety of a system, this method making it possible, on the one hand, to detect and to locate an anomaly of a system, and on the other hand to estimate the impact of such an anomaly on the degradation of performance, with a view to attaining the safety level required and to making the data provided by this system safe. This method must also make it possible to loosen the qualitative constraints on the process of developing an item of equipment or a sub-assembly of this item of equipment by allowing the use of components of a development level that a priori is not in accordance with their use in an avionics system.

The method in accordance with the invention is characterized in that it consists, in a system comprising sub-assemblies, in monitoring the proper operation of sub-assemblies or of their components by checking their respective transfer functions in the operational mode with the aid of stimuli dispatched to these sub-assemblies. Subsequently, the subject of the monitoring will be referred to interchangeably as a system, sub-assembly or component.

The device for implementing the method of the invention, for monitoring a system is characterized in that it comprises a stimuli generator, a device for managing the stimuli generator, and a device for analysing the output signals of the system to be made safe. In an advantageous manner, it also comprises a device for observing and controlling the responses and for estimating the safety obtained.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a simplified block diagram of a device for implementing the method of the invention,

FIG. 2 is a block diagram of a GNSS receiver for implementing the method of the invention.

### DETAILED DESCRIPTION OF THE INVENTION

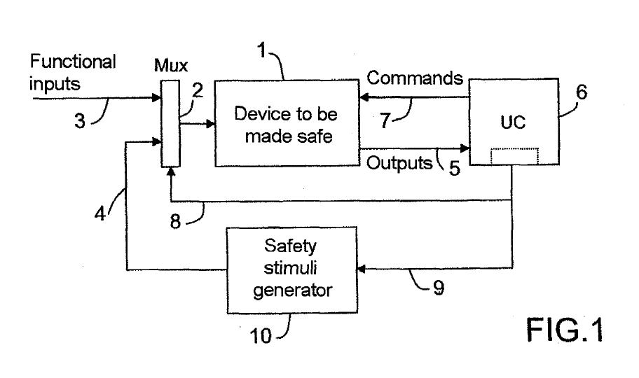

The invention is described in detail below with reference to its application to a GNSS receiver, but it is of course not limited to this application alone, and may be implemented in any system (such as that shown diagrammatically in FIG. 1 and briefly described below) in which a high level of integrity is required and/or in which the use of standard sub-assemblies not possessing the necessary safety level is not conceivable in the current state of the prior art.

The method of the invention makes it possible to detect in a radionavigation receiver of GNSS type any anomaly of its transfer function and to locate it, and also to estimate its impact on the performance of this receiver. The anomalies in question are, in particular, hardware faults, hardware drifting (aging and/or effect of temperature), hardware and software design errors. This method calls upon a device for monitoring non-compliant components of a system, this monitoring making it possible to check the integrity of the system. This monitoring device is integrated into the system and developed to a development level in accordance with that of the system. The integrity of the component is then guaranteed by the integrity and by the availability of its monitoring system. The invention is particularly, but not exclusively, appropriate to systems in which a non-compliant component (or several components) makes a measurement of a physical or electrical quantity. In the event of a defect in the integrity of a component detected by the monitoring system, the remainder of the system can be alerted, thereby making it possible to ensure the overall safety of the system. Another advantage of this monitoring device is that of detecting any hardware faults of a non-compliant component.

The checking of the complete transfer function of a complex system being too difficult to implement, the invention proposes to monitor this transfer function for the configuration of this system as used in the operational mode.

With respect to the known conventional methods, the method of the invention does not require any deep analysis of the elements contained in the function checked. It is therefore applicable, for example, to systems comprising modules developed for applications requiring only a lesser safety level, but nevertheless makes it possible to attain the safety level required. Moreover, it makes it possible to carry out the analysis of the checked system at the nominal operating point, and optionally around this point. This method must therefore be implemented in the operational phase of the checked systems, since the values of the stimuli are dependent on the configuration of the systems that is used.

It should however be noted that the method of the invention does not provide any additional guarantee as regards the availability of a non-compliant component. It is therefore implemented only when an integrity constraint justifies the system development level, as is, for example, the case for avionics sub-systems, and notably the case for satellite radionavigation systems, which are not a primary navigation means, and whose unavailability does not therefore give rise to a “catastrophic” situation.

The method of the invention consists in particular in verifying that responses of a component being monitored forming part of a system to monitoring stimuli comply with its specification. These monitoring stimuli use the operational input and output signals of this component. The stimuli can either be superimposed on these operational signals, or be substituted for them in a momentary manner. In the event that a non-integrity is detected, the latter is signalled to the system. The monitoring can be either continuous, or be cyclic with a recurrence frequency that is at minimum compatible with the safety requirements of the system, that is to say the time span between two consecutive monitoring tests must be less than the duration beyond which an erroneous data item produced by this component may give rise to a catastrophic situation.

According to a variant of the method of the invention, the test stimuli are calculated and applied to the component to be monitored in such a way that the theoretical response of the component is identical to its last operational response. It is thus possible to permanently tailor the testing of the component to its functional operating zone.

Represented in FIG. 1 is a device 1 to be made safe to the input of which is wired a multiplexer or similar device 2 receiving functional input signals 3, and stimuli 4, described below. The device 1 can comprise an arbitrary number of sub-assemblies. The outputs 5 of the device 1 are linked in an appropriate manner to a processor 6, which dispatches control signals 7 to it. Furthermore, the processor 6 dispatches control signals 8 to the multiplexer 2 and control signals 9 to a stimuli generator 10. Thus, the processor 6 forces the multiplexer to transmit to the device 1 either the functional input signals 3, or the stimuli 4, depending on whether the device 1 is operating conventionally or must receive the stimuli. The processor 6 is controlled by a specific program making it possible to generate the stimuli necessary for ensuring the optimal safety of the device 1, to control the dispatching of these stimuli (4) and for analysing the output signals 5. This check is made either by testing the device 1 for its operating point used by its operational function, or by analysis around this point.

In an advantageous manner, the implementation of the method of the invention is rendered non-disruptive if there is a hardware redundancy allowing the device 1 to be made safe sequentially in blocks of sub-assemblies of the overall function of the device 1. For example, in the case of a device for processing the radionavigation signals received from satellites, this device being composed of several parallel processing pathways each assigned to one of the satellites of a received constellation of satellites, it is possible to append a surplus channel, identical to the other channels, so as each time to release, by dynamic reassignment of pathways, one of these pathways and test it without disrupting the reception and processing of the signals received from the various satellites.

The choice of the stimuli is an important characteristic of the invention. It is determined by analysing the function implemented by the device to be tested receiving these stimuli, through the knowledge, even partial, of the architecture of this device, of the performance level demanded and of the impact of the performance of this device on the quality of the system incorporating this device. Complementary procedures are implemented to make it possible to determine the characteristics of these stimuli (logical analysis, path analysis, statistics, etc.). An essential condition is to choose these stimuli so that they are representative of the current operating point of the tested device (same exchange configuration or equivalence), so as to check the device at its point of use or around this point.

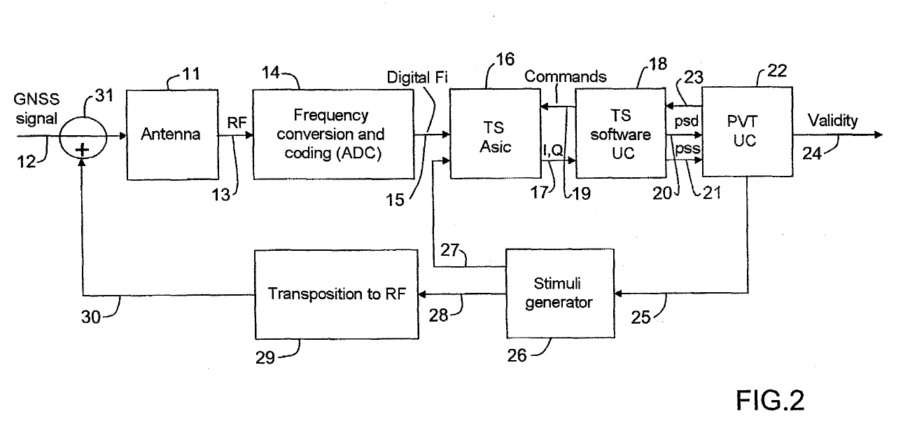

Shown diagrammatically in FIG. 2 is a GNSS radionavigation receiver to which the safety device according to the invention has been appended. This assembly comprises a reception antenna 11 for receiving radionavigation signals 12 sent by satellites. The RF signals 13 produced by the antenna 11 are dispatched to an analogue/digital converter 14 for frequency conversion and coding. The intermediate-frequency output digital signals 15 are dispatched to a dedicated signal processing circuit 16, embodied for example in the form of an ASIC. The circuit 16 dispatches signals 17 known by the conventional denomination I and Q to a signal processing management processor 18 from which it receives control signals 19. The processor 18 dispatches signals 20 (“psd” for pseudo-distance) and 21 (“pss” for pseudo-speed) to a processor 22 which dispatches control signals 23 to it and which sends signals 24 of validity/non-validity of the radionavigation signals received by the antenna 11. The processor 22 is the location processor customarily fitted to the receiver. Furthermore, the processor 22 comprises a monitoring function which sends a signal (25) for controlling a stimuli generator 26. The generator 26 dispatches its stimuli to the circuit 16 through the link 27. As a variant, the generator 26 dispatches its stimuli to a frequency transposition circuit 28 (transposition to the same RF frequency as that of the satellite signals 12) whose output signals are dispatched (30) to a coupler 31 plugged into the input of the antenna 11 and receiving on the other hand the signals 12.

The safety device combined with the radionavigation receiver of FIG. 2 allows two important functions of this receiver to be made safe, namely:
the signal processing circuit generating the pseudo-measurements I and Q,
the frequency converter and analogue/digital converter circuit 14 of the reception chain.

Management of the stimuli is checked according to two checking levels:
checking of the circuit 16 by using its natural output signals after their processing by the processors 18 and 22,
checking of the reception chain by using its natural output signals processed by the circuit 16 (already made safe by the previous check).

The safety software is installed in the processor 22 with appropriate segregation and an appropriate development level. It will be noted that the overall testing of the radionavigation receiver with the aid of stimuli also allows software functions installed in the processor 18, and in particular signal processing functions, to be made safe.

In the application, described above, to a GNSS radionavigation receiver, the correlation function installed in the circuit 16 must carry out the correlation of the input signal 12 with a local replica of the GNSS signals received that is slaved to these signals, so as to calculate the correlation function locally, for example over 32 adjacent time lags, at a tempo of half a chip, doing so for all the satellites to be tracked. This correlation function can be subdivided into four sub-assemblies:
input of the samples (15),
generation of the local replica of the GNSS signals, with read-checking of the GNSS signals and write-checking of their replica,
correlation (complex product): this correlation is effected in a customary manner, since, by assumption, the stimuli are the most exact possible replica of the real GNSS signals,
filtering of the correlation product, also performed in a customary manner.

A criticality analysis shows that an important characteristic of the invention is the generation and checking of the replica of the GNSS signals, the other elements (correlation-based filtering, optional encryption, etc.) having discernable effects during nominal operation of the receiver. In order to check this assembly at the current operating point of the receiver, it is possible to generate a “like” signal (replica, encrypted or not, of the GNSS signal for this current operating point) dispatched to the coupler 31 and to check all the filtered output signals of the circuit 16, representing the correlation function, namely a correlation performed for the maximum signal on the “punctual” pathway, for the reduced amplitude signal on the pathways adjacent to this punctual pathway and for the practically zero signal for the other pathways. This makes it possible to validate the check of the local replica of the GNSS signal and of the calculation of the correlation function.

In conclusion, the invention makes it possible to detect and to quantify the effects of a malfunction of a system such as a radionavigation receiver. It is thus possible to enhance the latter's capabilities in regard to safety, in particular when strategic applications are involved. Generally, the invention makes it possible to guarantee the integrity of a component and/or of a system by checking its proper operation at the instant considered and in the operating domain considered.

The relative simplicity of the means required to implement the method of the invention, namely the processing algorithm which can be installed in an existing computer (with segregation between this algorithm and the other functions of the computer) or indeed installed in a small dedicated computer associated with a small ASIC (or FPGA) circuit, with the development level suited to the integrity requirements to be complied with, enables its low-cost integration into the majority of military or civil GNSS signal receivers.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. Method of improving the integrity and safety of a system, in a system having sub-assemblies, the steps of:
monitoring the proper operation of sub-assemblies or of their components by checking their respective transfer functions in the operational mode with the aid of stimuli dispatched to these sub-assemblies.

2. Method according to claim 1, wherein the stimuli are superimposed on the operational input signals of the sub-assemblies.

3. Method according to claim 1, wherein the stimuli are substituted in a momentary manner for the operational input signals of the sub-assemblies.

4. Method according to claim 1, wherein the monitoring is performed in a continuous manner.

5. Method according to claim 1, wherein the monitoring is performed in a cyclic manner with a recurrence frequency that is at minimum compatible with the safety requirements of the system.

6. Method according to claim 1, wherein the test stimuli are calculated and applied to the component or sub-assembly to be monitored in such a way that its theoretical response is identical to its last operational response.

7. Method according to claim 1, wherein it is implemented for a GNSS radionavigation receiver and that the stimuli are a local replica of the GNSS signals received, this replica being slaved to these signals.

8. Method according to claim 7, wherein the replica is an encrypted replica of the GNSS signal.

9. Device for implementing the method according to claim 1, for monitoring a system, wherein it comprises a stimuli generator, a device for managing the stimuli generator, and a device for analysing the output signals of the system to be made safe.

10. Device according to claim 9, wherein it also comprises a device for observing and controlling the responses and for estimating the safety obtained.

11. Device according to claim 9, wherein it forms part of a GNSS radionavigation receiver.

12. Method according to claim 11, wherein the stimuli generator is linked directly to an input of the circuit for formulating the pseudo-speed and pseudo-distance signals of the GNSS receiver.

13. Method according to claim 11, wherein the stimuli generator is linked by way of an RF transposition circuit and of a coupler to the antenna of the GNSS receiver.

14. Method according to claim 2, wherein the monitoring is performed in a continuous manner.

15. Method according to claim 3, wherein the monitoring is performed in a continuous manner.
